(19) United States
(12) Patent Application Publication
(10) Pub. No.: US 2026/0093610 A1
(43) Pub. Date: Apr. 2, 2026

(54) INTELLIGENT AUTOMATED TEST CASE GENERATION METHOD AND APPARATUS

(71) Applicant: VERIZON PATENT AND LICENSING INC., Basking Ridge, NJ (US)

(72) Inventors: Pallavi AGGRAWAL, Hyderabad (IN); Annu SINGH, Hyderabad (IN)

(73) Assignee: VERIZON PATENT AND LICENSING INC., Basking Ridge, NJ (US)

(21) Appl. No.: 18/904,249

(22) Filed: Oct. 2, 2024

(51) Int. Cl. G06F 11/36; G06F 8/71; G06F 40/284

(52) U.S. Cl. CPC G06F 11/3688; G06F 8/71; G06F 11/3684; G06F 40/284

(57) ABSTRACT

Techniques for intelligent automated test case generation are disclosed. In one embodiment, a method is disclosed comprising generating a testing context comprising information identifying at least one difference between first and second code commit versions, generating model input using the testing context, generating a testing script using a trained natural language processing (NLP) model and the model input, and testing the second code commit version using the generated testing script.

### BACKGROUND INFORMATION

Before a software application is made available for use, the software application typically undergoes testing to certify its readiness for production and roll out to the users. The testing and certification process can involve testing the user interface, testing the code, or the like, using various testing methodologies, often using test cases, each of which can focus on testing one or more aspects of the software application. Software testing and certification can be time consuming and error-prone and can cause delays in making a software application available to users.

### BRIEF DESCRIPTION OF THE DRAWINGS

FIG. 1 provides an example illustrating test case and automation script generation in accordance with one or more embodiments of the present disclosure;

FIG. 2 provides an testing script generation process flow in accordance with one or more embodiments of the present disclosure;

FIG. 3 provides an exemplary testing context generation process flow illustrating operations that can be performed in accordance with one or more embodiments of the present disclosure;

FIG. 4 provides an exemplary test case and script generation process flow using a tokenizer and transformer model in accordance with one or more embodiments of the present disclosure;

FIG. 5 provides an example of a model output decoding and processing process flow in accordance with one or more embodiments of the present disclosure;

FIG. 6 provides a code commit example in accordance with one or more embodiments of the present disclosure;

FIG. 7 provides an example illustrating context information in accordance with one or more embodiments of the present disclosure;

FIGS. 8 and 9 provide an example of a testing script in accordance with one or more of the disclosed embodiments;

FIG. 10 provides an example of a testing framework for use in accordance with one or more embodiments of the present disclosure; and

FIG. 11 depicts is a schematic diagram illustrating an example of a computing device in accordance with some embodiments of the present disclosure.

### DETAILED DESCRIPTION OF EXAMPLE EMBODIMENTS

Techniques for intelligent automated test case generation are disclosed. Disclosed embodiments can be used to automate test case generation using artificial intelligence.

Embodiments of the present disclosure automatically generate test case scripts in accordance with contextual information, such as and without limitation commit messages, code differences, file type information and target test case example information, associated with the code that is to be tested. Embodiments of the present disclosure can use various artificial intelligence techniques here, including a deep learning model, such as and without limitation a transformer model, to generate test cases and corresponding automated scripts using the contextual information. The test cases and scripts can be used to test the code. By way of a non-limiting example, the transformer model can be from a transformer library, such as Hugging Face's transformer library. By way of a further non-limiting example, the transformer model can be a Bidirectional Encoder Representations from Transformers (BERT) , T5, etc. transformer model.

A test case and corresponding script can be used with a computer-executable version of source code to test the source code. A test case can measure functionality of the code across a set of actions or conditions to verify whether or not an expected result (e.g., a specific requirement) is achieved. Code can be used herein to refer to source code as well as a computer-executable version of the source code. A computer executable version of source code can be generated by a compiler, interpreter, etc.

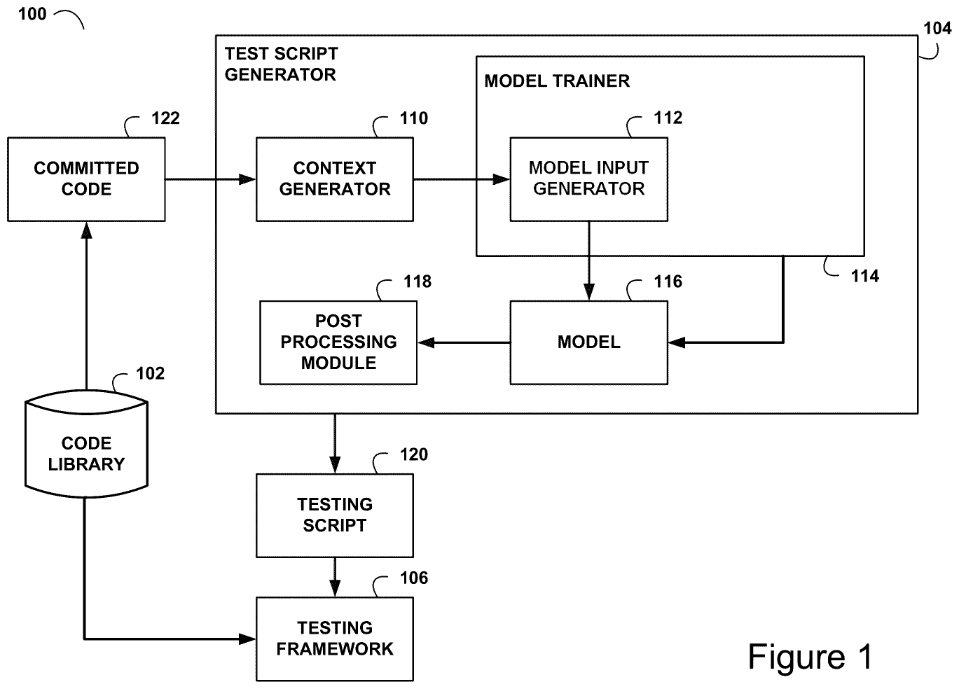

FIG. 1 provides an example illustrating test script generation in accordance with one or more embodiments of the present disclosure. In accordance with one or more embodiments, as shown in example 100, test script generator 104 can receive committed code 122 from code library 102 (e.g., a code repository) and can generate testing script 120. In accordance with one or more embodiments, testing script 120 can comprise a number of test cases and a script, or function, corresponding to each test case that can be used by testing framework 106 to test committed code 122 from code library 102. In example 100, generator 104 can comprise a context generator 110, a model input generator 112, model trainer 114, model 116 and post processing module 118.

In accordance with one or more embodiments, the code received by generator 104 from code library 102 can comprise first and second code commit versions, where the second code commit version is an updated version of the first. Testing script 120 can be used by testing framework 106 to test differences between the first and second code commit versions, as is discussed in more detail herein.

In accordance with one or more embodiments, context generator 110 can generate context information, which can be used by model input generator 112 to generate model input used by model 116 to generate model output comprising tokenized, or encoded, test case and script (or automation script) output, which can be decoded and further processed by post processing module 118 to generate testing script 120. In accordance with one or more embodiments, the model input generator 112 can generate tokenized, or encoded, model input using the context information, which includes code change, file type, commit message and test case example information. In example 100, while model input generator 112 is shown as a part of model trainer 114, model input generator 112 can be a separate component. As shown in example 100, model 116 can be trained by model trainer 114. The trained model 116 can use the tokenized model input to generate model output that can be used to generate testing script 120.

In example 100, code library 102 can be a global information tracker (GIT) repository. It should be apparent that any type of information management system capable of storing and tracking versions of digitally stored information, or files, can be used with embodiments of the present disclosure.

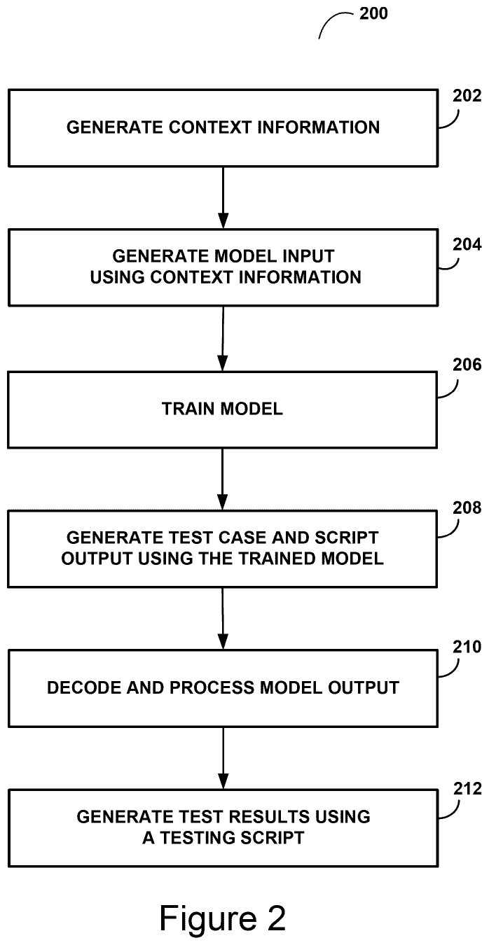

FIG. 2 provides an testing script generation process flow in accordance with one or more embodiments of the present disclosure. Process flow 200 can be executed by generator 104. At step 202, a context information can be generated. By way of a non-limiting example, step 202 can be performed by context generator 110. By way of some further non-limiting examples, the context information generated in connection with the second code commit version can comprise code change, file type, commit message, and manual and automation test case example information. As discussed herein, the code change information comprises information identifying changes, or differences, between the first and second code commit versions.

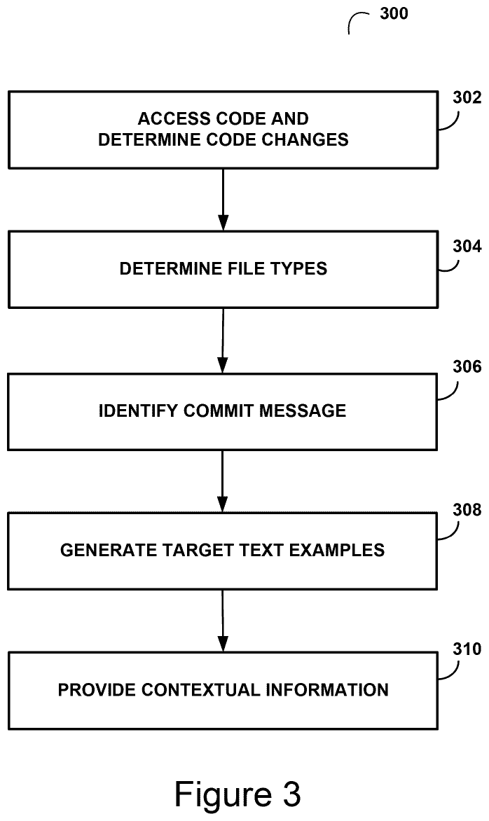

FIG. 3 provides an exemplary context information generation process flow illustrating operations that can be performed at step 202 by context generator 110. In example 300, the process flow can comprise steps 302, 304, 306, 308 and 310. At step 302, code can be accessed and code changes can be determined. By way of a non-limiting example, the first and second code commit versions can be accessed using commit identification information, such as and without limitation, commit ID. By way of a further non-limiting example, a commit ID can be assigned to the first and second code commit versions when each is committed to code library 102. To further illustrate, the commit ID assigned to each commit can be generated using a hash_commit function which can use information such as content of the commit, changes made, author information, timestamp information, information identifying the parent commit, etc., to generate the hashed commit ID. By way of a non-limiting example, commit_hash_1 and commit_hash_2 can be the commit IDs representing the first and second code commits that can be used to access a repository storing the first and second code commits.

In accordance with one or more embodiments, at step 302, context generator 110 can analyze the first and second code commits to identify, or extract, changes, or differences, between the two commits. By way of a non-limiting example, a diff function can be used to determine changes, or differences, between the first and second code commit versions with assigned IDs of commit_1 and commit_2, respectively, at step 302. By way of a further non-limiting example, context generator 110 can classify each difference as being a certain type of difference, such as and without limitation, added, deleted, modified, renamed or copied code change.

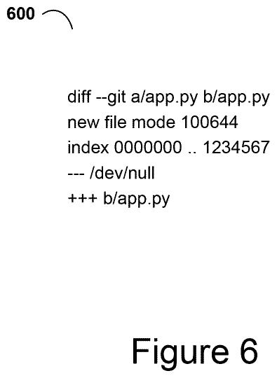

By way of another non-limiting example, the commit difference(s) can include a new piece of code that is being added. FIG. 6 provides an example 600 of a GIT commit command, or operation, in which a new file, b/app.py, which includes new code, is being added as part of the commit operation. In accordance with one or more embodiments, context generator 110 can analyze the GIT commit information shown in example 200 and identify the new file as a code commit difference.

Embodiments of the present disclosure are described in connection with exemplary code added as part of a code commit operation. With reference to FIG. 1, the new code can be committed code 122. As shown in example 100, the committed code 122 is input to generator 104. By way of a non-limiting example, the new code can be designed to receive and process username and password input as part of a new user login procedure. Context generator 110 can identify the exemplary new code as a commit difference—e.g., added code—that is to be tested.

Referring again to FIG. 3, at step 304, file types can be determined. By way of a non-limiting example, context generator 110 can identify the file type information, which also provides coding language information, for the committed code using file extensions. With reference to FIG. 6, the two files listed in the GIT commit shown in example 600 both use the .py file extension indicating that they are Python® files.

At step 306, of FIG. 3, a commit message can be determined. A commit message is typically provided as part of the commit command (e.g., by the developer or author of the code) to explain the reasoning for the change that is being made. In example 600, the GIT commit includes a message indicating that a new file is being added.

At step 308, of FIG. 3, target text examples can be generated. In accordance with one or more embodiments, target text examples provide a template, or templates, for the test case model output generated by model 116. By way of a non-limiting example, context generator 110 can generate target text examples using the code changes identified at step 302. At step 310, contextual information can be provided. By way of a non-limiting example, the contextual information determined by context generator 110 and comprising code change, file type, commit message and target text example information can be provided by context generator 110 to model input generator 112.

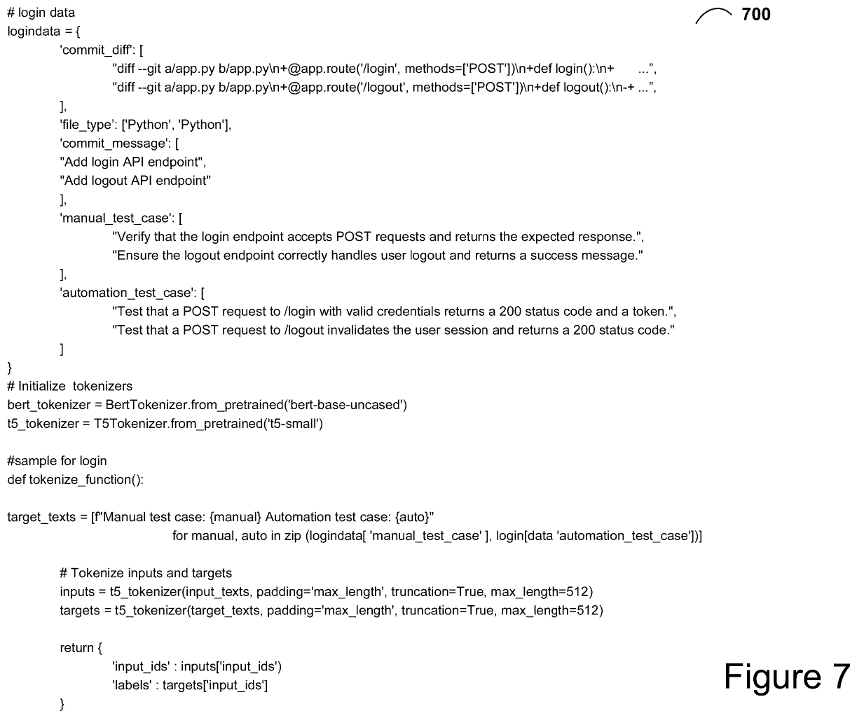

FIG. 7 provides an example illustrating context information in accordance with one or more embodiments of the present disclosure. In example 700, lines 2-19 provide an example of contextual information including commit difference, file type, commit message and target test case example that can be generated by context generator 110 in connection with the committed code 122. As discussed in connection with the login procedure code example, committed code 122 can be the exemplary login procedure code.

Referring again to FIG. 2, at step 204, model input can be generated using context information. Step 204 can be performed by model input generator 112. By way of a non-limiting example, contextual information generated at step 202 can be used by model input generator 112 to generate model input.

In accordance with one or more embodiments, model input generator 112 can tokenize the contextual information using a tokenizer, such as a BERT tokenizer. The tokenized model input comprises a number of tokens, or internal representations of the context information. In accordance with one or more such embodiments, the model can be a BERT, T5, etc. transformer model. Embodiments of the present disclosure are described with reference to a BERT transformer model. It should be apparent that other transformer models, such as the T5 transformer model, can be used. The BERT transformer model is a natural language processing model with a neural network architecture. The BERT transformer can use the tokenized input to generate tokenized output representing a number of test cases and corresponding scripts, as is discussed in more detail below.

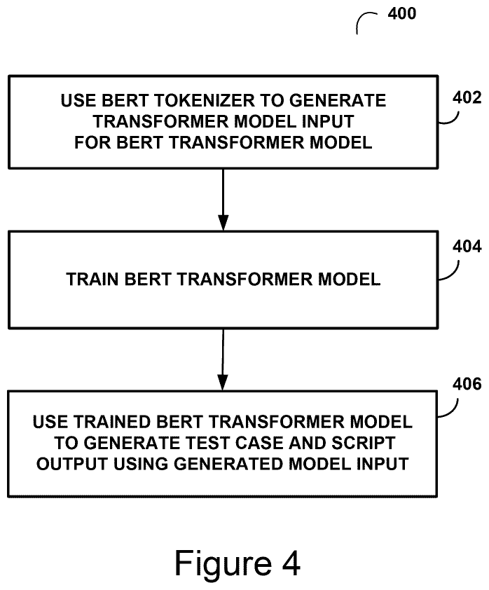

FIG. 4 provides an exemplary test case and script generation process flow using a BERT tokenizer and BERT transformer model in accordance with one or more embodiments of the present disclosure. Steps 402, 404 and 406 can correspond, respectively, to steps 204, 206 and 208 of FIG. 2.

At step 402, a BERT tokenizer can be used to generate transformer model input for a BERT transformer model. By way of a non-limiting example, a prepare_model_input function can be used with the context information, generated at step 202 of FIG. 2, to generate the model input for the BERT transformer model. By way of a further non-limiting example, the BERT tokenizer can perform the prepare_model_input function and use the context information generated at step 202 to generate the model input. The generated model input can be tokenized model input. As discussed, the context information can comprise code change, file type, commit message, target text example information.

In accordance with one or more embodiments, step 402 can pre-process the context information before generating the model input. By way of a further non-limiting example, the file types contextual information can be converted into a string that joins, or combines, each identified file type. By way of a further non-limiting example, the pre-processing can include generating an input text string using the contextual information, where each contextual information item is added to the text string along with labeling information (e.g., Commit_message:, File types:, etc.) and a value, n, indicating the length of the contextual information item. The following provides an example of an exemplary input text string generation expression, which refers to the generated input text string as input_text:

```
input_text = ″Commit message: ″ + commit_message + ″\n″ + \
  ″File types: ″ + file_types_str + ″\n″ + \
  ″Code changes:\n″ + code_change + ″\n″ + \
  ″Manual_test_case: ″ + manual_test_case + “\n” \
  “Automation_test_case: “ + auto_test_case
```

By way of a non-limiting example, an encode_input_text function can be used to generate tokenized model input from the input_text. By way of a further non-limiting example, the BERT tokenizer can be used to provide the encode_input_text functionality to generate the tokenized model input.

Referring again to FIG. 7, lines 21-38 further illustrate the step 402 of example 400. At lines 21-23, the BERT tokenizer can be initialized and then used at lines 31-33 (which correspond to step 402 in example 400) to generate the tokenized model input.

Referring again to FIG. 2, at step 206, a model can be trained. By way of a non-limiting example, the trained model can be model 116. By way of a non-limiting example, step 206 can be performed by model trainer 114 to train model 116.

In accordance with one or more embodiments, model 116 can be a BERT transformer model, which can be used to generate model output. In accordance with one or more embodiments, the model output comprises tokens that can be used to generate testing script 120. As shown in example 400, at step 404, the BERT transformer model can be trained. The trained BERT transformer model can correspond to model 116 and can be used to generate testing script 120.

By way of a non-limiting example, step 404 can involve initializing the BERT transformer model, generating a training dataset to train the BERT transformer model, generating training arguments for training the BERT transformer model, initializing the model trainer used to train the BERT transformer model and training the BERT transformer model using the initialized model trainer. These steps are further illustrated in the following exemplary code:
123 from transformers import T5ForConditionalGeneration, Trainer, TrainingArguments
124 import torch
125 from datasets import Dataset
126 #Initialize the T5 model
127 model=T5ForConditionalGeneration.from_pretrained(‘t5-small’)
128 #Convert to Hugging Face dataset
129 dataset=Dataset.from_pandas(pd. DataFrame(tokenized_data.tolist( )))
130 #Generate training arguments
131 training_args=TrainingArguments
132 per_device_train_batch_size=2,
133 num_train_epochs=3,
134 logging_dir=‘./logs’,
135 save_steps=10_000,
136 eval_steps=10_000,
137 prediction_loss_only=True
138 testcasedescription=‘.logindata’
139 input=‘.logindata’
140 output=‘logindata’
141 method type=‘GET,POST,DELETE,PUT’
142 )
143 #Initialize Trainer
144 trainer=Trainer(
145 model=model,
146 args=training_args,
147 train_dataset=dataset
148 )
149 #Train the model
150 trainer.train ( )

In the exemplary code shown above, the transformer model is a T5 model, which can be initialized at lines 126-127, a training data set can be generated at lines 128-129, training arguments can be generated at lines 130-142, the model trainer can be initialized at lines 143-148, and the model trainer can be used to train the transformer model at lines 149-150. It should be apparent that a similar set of steps can be used to train a BERT transformer model.

With reference to FIG. 2, at step 208, test case and script output can be generated using the trained model. By way of a non-limiting example, the test case and script output can be generated by model 116 trained by model trainer 114. With reference to FIG. 4, at step 406, the trained BERT transformer model can be used to generate test case and script output using generated model input. In example 400, the generated model input can be generated, at step 402, using a BERT tokenizer.

By way of a non-limiting example, step 406 can use a trained. model function to generate model_output using model_input as input. By way of a further non-limiting example, the trained.model function can be performed by a trained BERT transformer model. The model input can be the tokenized model input generated, at step 402, by the BERT tokenizer using the contextual information generated by the context generator 110, and the model output can comprise the test case and script output generated by the trained BERT transformer model, at step 406. The model output generated by the BERT transformer model can be in tokenized form.

With reference to FIG. 2, at step 210, the model output can be decoded and processed. By way of a non-limiting example, step 210 can be performed by post processing module 118 to generate testing script 120. Post processing module 118 can decode and process the output of the BERT transformer to generate testing script 120.

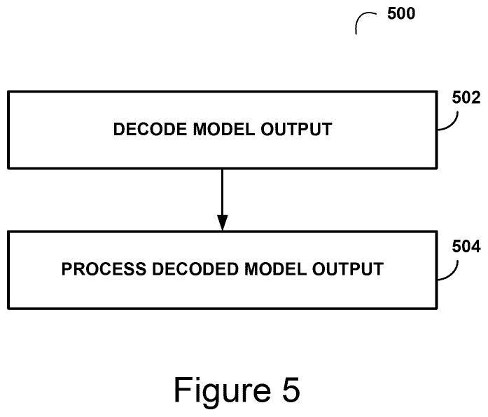

FIG. 5 provides an example of a model output decoding and processing process flow in accordance with one or more embodiments of the present disclosure. In example 500, at step 502, the model output can be decoded. By way of a non-limiting example, a decode_model_output function can be used to decode the model output and generate a decoded_script using model_output. The decode_model_output function can be performed by the BERT tokenizer, which can decode the model output by de-tokenizing the tokenized output of the BERT transformer model, at step 502. As shown in example 500, step 504 can be performed to process the decoded model output. By way of a non-limiting example, a function_clean function can be used to further format and clean the de-tokenized output of the BERT tokenizer. The processing of the decoded model output can further include a step that cleans and formats the decoded model output, removes any unnecessary tokens or text, and performs any additional formatting, such as and without limitation adding indentation formatting and comments. Step 504 can be performed to process the model output and generate testing script 120.

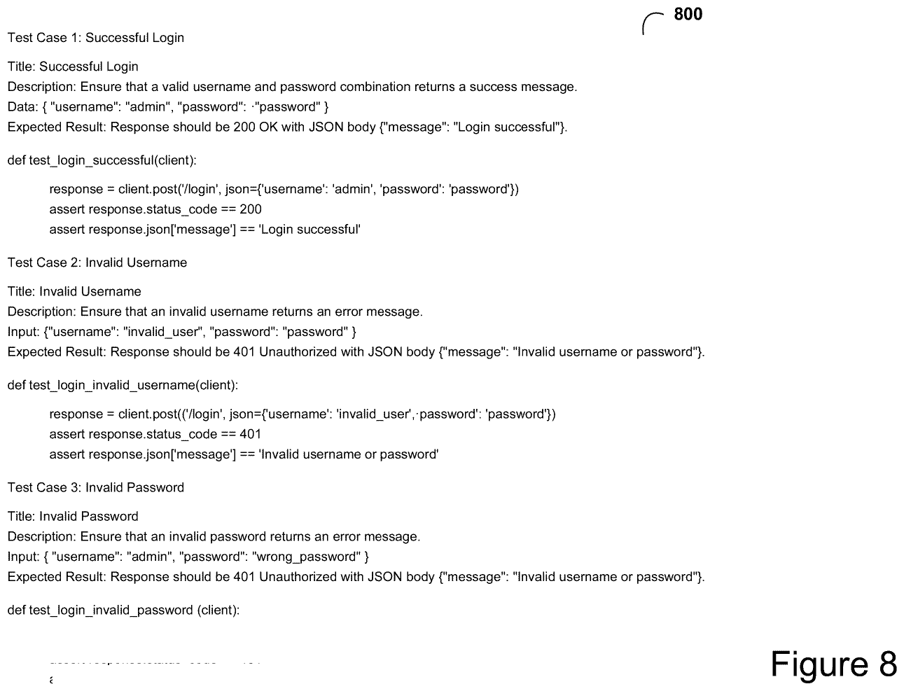

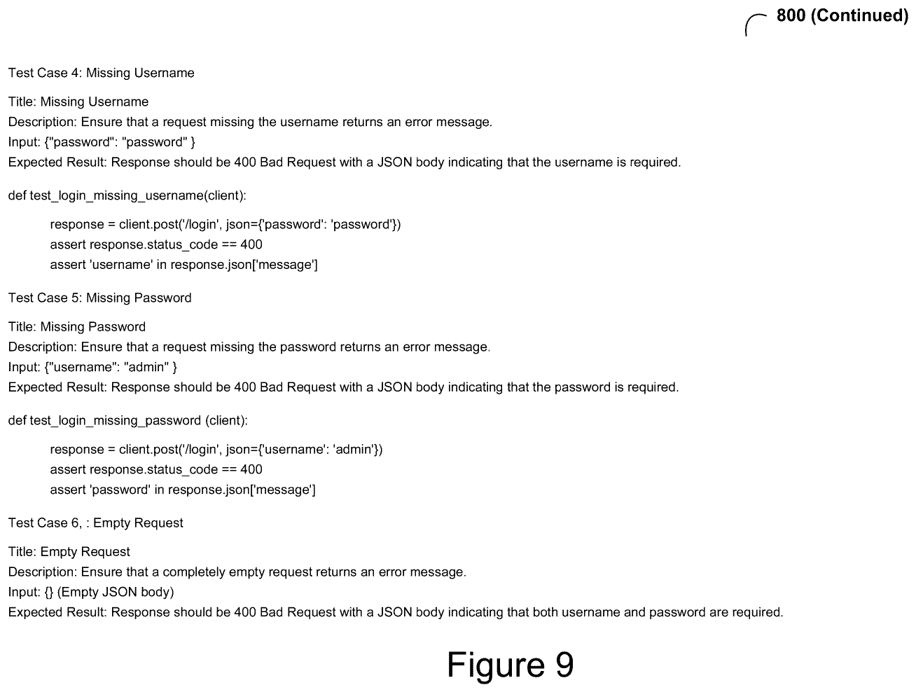

FIGS. 8 and 9 provide an example of a testing script 120 in accordance with one or more of the disclosed embodiments. Continuing with the login procedure code example, the exemplary testing script 120 shown in example 800 can be used to test the new login procedure code. Example 800 includes six test cases. Each test case corresponds to a certain testing scenario and can be used to execute the login procedure code to determine whether the program performs as expected given the testing scenario. Each test case can specify a result, or outcome, that is expected from executing the new login procedure code based on certain conditions, e.g., certain input.

Referring again to FIG. 2, at step 212, test results can be generated using a testing script. By way of anon-limiting example, step 212 can be performed by testing framework 106 using testing script 120.

As discussed, example 800 of FIGS. 8 and 9 provides an example of a testing script 120. Continuing with the login procedure code example, testing framework 106 can use test cases from testing script 120 shown in example 800 to test the new login procedure code.

Testing script 120 can include a number of test cases, each of which can be designed to testing a certain scenario with an associated set of actions, conditions, etc.

By way of a non-limiting example, test case 1, which is titled Successful Login, corresponds to a testing scenario involving a successful login. In test case 1, the testing scenario involves testing the new login procedure code under conditions in which the code receives a valid username and password combination; and, ensuring that the new login procedure code correctly processes the valid input and returns a response indicative of a successful login. The test case includes information defining the scenario being tested and a function, e.g., a script. In example 800, the definitional information can be used to assign valid values to the username and password variables and to identify an expected result.

The test case's function can be used to execute the login procedure code, supply the assigned values to the code, examine the response received from the code and provide the response. In test case 1, test_login_successful is a script corresponding to test case 1 that can be run by testing framework 106. Testing framework 106 can use the test_login_successful function to test the new login procedure code using the defined username and password values. Testing framework 106 can use test_login_successful function defined in test case 1's script to examine the response generated by the login procedure to ensure that the response corresponds to the result expected given the username and password values assigned in test case 1.

Example 800 includes a number of test cases designed to test various scenarios including scenarios involving an invalid username, an invalid password, a missing user name, a missing password, and a login request that is missing both a username and a password. Testing framework 106 can use the test cases shown in example 800 to test that the new login procedure code handles each one of the scenarios and provide the expected result specified by each one of the test cases.

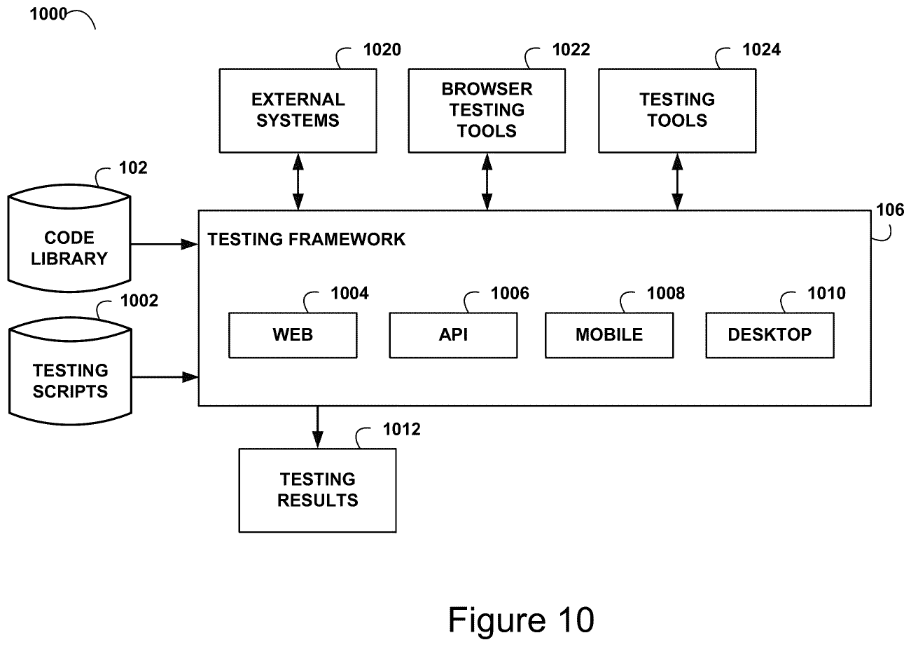

FIG. 10 provides an example of a testing framework for use in accordance with one or more embodiments of the present disclosure. As shown in example 1000, testing framework 106 has the ability to test different types of applications, such as without limitation web 1004, application programming interface (API) 1006, mobile 1008 and desktop 1010 applications. By way of a non-limiting example, API applications 1006 can be JavaScript® applications.

Testing framework 106 can access external systems 1020, such as and without limitation database management, test case management, testNG® or other Java testing frameworks, and electronic messaging systems. Testing framework 106 can access browser testing tools 1022, such as Selenoid® and BrowserStack®, Selenium's WebDriver, Healenium's AI Self Healing library and Open-Source Web Application Security Project's (OWASP's) security testers, and the like. Testing framework 106 can use various testing tools 1024, such as and without limitation Applitools'Visual Testing, Gremlins'Monkey Testing, Axe Core's Accessibility Testing, and the like.

As shown in example 1000, testing framework 106 can access code library 102 and testing scripts library 1002 to retrieve the code, e.g., committed code 122, that is to be testing using one or more testing scripts. By way of a non-limiting example, testing framework 106 can retrieve the new login procedure code and the testing script shown in example 800, and use the retrieved testing script to test the retrieved code. Testing framework 106 can provide testing results 1012 generated by testing framework 106 based on the retrieved code and testing script(s). By way of a non-limiting example, the testing framework 106 can provide testing results 1012 via a user interface, such as a dashboard user interface.

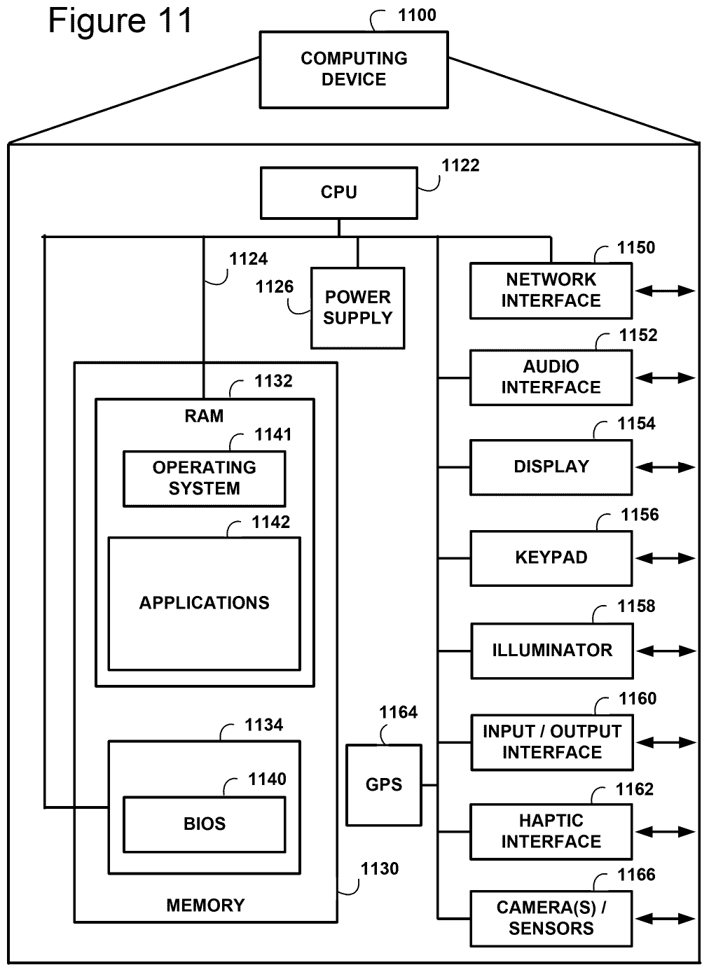

FIG. 11 is a schematic diagram illustrating an example embodiment of a computing device that may be used with embodiments of the present disclosure. Device 1100 may include many more or less components than those shown in FIG. 11. However, the components shown are sufficient to disclose an illustrative embodiment for implementing the present disclosure. Device 1100 may represent a computing device that can be used in accordance with embodiments of the present disclosure.

As shown in the figure, device 1100 includes a processing unit (CPU) 1122 in communication with a mass memory 1130 via a bus 1124. Device 1100 also includes a power supply 1126, one or more network interfaces 1150, an audio interface 1152, a display 1154, a keypad 1156, an illuminator 1158, an input/output interface 1160, a haptic interface 1162, an optional global positioning systems (GPS) transceiver 1164 and a camera(s) or other optical, thermal or electromagnetic sensors 1166. Device 1100 can include one camera/sensor 1166, or a plurality of cameras/sensors 1166, as understood by those of skill in the art. The positioning of the camera(s)/sensor(s) 1166 on device 1100 can change per device 1100 model, per device 1100 capabilities, and the like, or some combination thereof.

Optional GPS transceiver 1164 can determine the physical coordinates of device 1100 on the surface of the Earth, which typically outputs a location as latitude and longitude values. GPS transceiver 1164 can also employ other geo-positioning mechanisms, including, but not limited to, triangulation, assisted GPS (AGPS), E-OTD, CI, SAI, ETA, BSS or the like, or may through other components, provide other information that may be employed to determine a physical location of the device, including for example, a MAC address, Internet Protocol (IP) address, or the like.

Mass memory 1130 includes a RAM 1132, a ROM 1134, and other storage means. Mass memory 1130 illustrates another example of computer storage media for storage of information such as computer readable instructions, data structures, program modules or other data. Mass memory 1130 stores a basic input/output system (“BIOS”) 1140 for controlling low-level operation of device 1100. The mass memory also stores an operating system 1141 for controlling the operation of device 1100.

Memory 1130 further includes one or more data stores, which can be utilized by device 1100 to store, among other things, applications 1142 and/or other data. For example, data stores may be employed to store information that describes various capabilities of device 1100. The information may then be provided to another device based on any of a variety of events, including being sent as part of a header during a communication, sent upon request, or the like.

Applications 1142 may include computer executable instructions which, when executed by device 1100, transmit, receive, and/or otherwise process audio, video, images, and enable telecommunication with a server and/or another user of another client device. Other examples of application programs or “apps” in some embodiments include browsers, calendars, contact managers, task managers, transcoders, photo management, database programs, word processing programs, security applications, spreadsheet programs, games, search programs, and so forth.

The present disclosure has been described with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, the subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “and,” “or,” or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer-readable medium (or computer-readable storage medium/media) stores computer data, which data can include computer-executable application program code (or computer-executable instructions) that is executable by a computer, in machine-readable form. By way of example, and not limitation, a computer-readable medium may comprise computer-readable storage media, for tangible or fixed storage of data, or communication media for transient interpretation of code-containing signals. Computer-readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer-readable storage media can tangibly encode computer-executable instructions that when executed by a processor associated with a computing device perform functionality disclosed herein in connection with one or more embodiments.

Computer-readable storage media includes, but is not limited to, RAM, ROM, EPROM, EEPROM, flash memory or other solid-state memory technology, CD-ROM, DVD, or other optical storage, cloud storage, magnetic storage devices, or any other physical or material medium which can be used to tangibly store thereon the desired information or data or instructions and which can be accessed by a computer or processor.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

1. A method comprising:
generating, by a computing device, a testing context comprising information identifying at least one difference between first and second code commit versions;
generating, by the computing device, model input using the testing context;
generating, by the computing device, a testing script using a trained natural language processing (NLP) model and the model input; and
testing, by the computing device, the second code commit version using the generated testing script.

2. The method of claim 1, generating a testing context further comprising:
generating commit message information, file type information and target test case examples information, wherein the testing context used in generating the model input further comprises the generated commit message, file type and target test case examples information.

3. The method of claim 2, further comprising:
extracting the commit message information and the file type information from a Global Information Tracker (GIT) commit command.

4. The method of claim 2, further comprising:
generating the target test case examples using the at least one identified difference between the first and second code commit versions.

5. The method of claim 1, generating model input further comprising:
tokenizing the model input, wherein the tokenized model input is used by the NLP model in generating the testing script.

6. The method of claim 5, wherein the tokenizing is performed using a BERT tokenizer, and the trained NLP model is a BERT transformer model.

7. The method of claim 5, wherein generating a testing script using a trained (NLP model further comprises:
receiving tokenized output; and
de-tokenizing the tokenized output.

8. The method of claim 1, wherein testing the second code commit version further comprises:
causing the second code commit version to be executed using a testing function and a testing scenario defined by the testing script; and
receiving, from the testing function, result information indicating whether the second code commit version responded correctly given the testing scenario.

9. The method of claim 8, wherein the testing scenario comprises information indicating a value for at least one variable supplied to the second code commit version via the testing function.

10. The method of claim 8, further comprising:
using a testing framework to perform the causing step, wherein the result information is received via the testing framework.

11. A non-transitory computer-readable storage medium tangibly encoded with computer-executable instructions that when executed by a processor associated with a computing device perform a method comprising:
generating a testing context comprising information identifying at least one difference between first and second code commit versions;
generating model input using the testing context;
generating a testing script using a trained natural language processing (NLP) model and the model input; and
testing the second code commit version using the generated testing script.

12. The non-transitory computer-readable storage medium of claim 11, generating a testing context further comprising:
generating commit message information, file type information and target test case examples information, wherein the testing context used in generating the model input further comprises the generated commit message, file type and target test case examples information.

13. The non-transitory computer-readable storage medium of claim 12, the method further comprising:
extracting the commit message information and the file type information from a Global Information Tracker (GIT) commit command.

14. The non-transitory computer-readable storage medium of claim 12, the method further comprising:
generating the target test case examples using the at least one identified difference between the first and second code commit versions.

15. The non-transitory computer-readable storage medium of claim 11, generating model input further comprising:
tokenizing the model input, wherein the tokenized model input is used by the NLP model in generating the testing script.

16. The non-transitory computer-readable storage medium of claim 15, wherein the tokenizing is performed using a BERT tokenizer, and the trained NLP model is a BERT transformer model.

17. The non-transitory computer-readable storage medium of claim 15, wherein generating a testing script using a trained NLP model further comprises:
receiving tokenized output; and
de-tokenizing the tokenized output.

18. The non-transitory computer-readable storage medium of claim 11, wherein testing the second code commit version further comprises:
causing the second code commit version to be executed using a testing function and a testing scenario defined by the testing script; and
receiving, from the testing function, information indicating whether the second code commit version responded correctly given the testing scenario.

19. The non-transitory computer-readable storage medium of claim 18, wherein the testing scenario comprises information indicating a value for one or more variables supplied to the second code commit version via the testing function.

20. A computing device comprising:
a processor, configured to:
generate a testing context comprising information identifying at least one difference between first and second code commit versions;
generate model input using the testing context;
generating a testing script using a trained natural language processing (NLP) model and the model input; and
test the second code commit version using the generated testing script.
